(19) United States
(12) Patent Application Publication
(10) Pub. No.: US 2007/0059124 A1
(43) Pub. Date: Mar. 15, 2007

(54) Portable personal wearable active third arm

(75) Inventors: Craig Eldershaw, Mountain View, CA (US); David G. Duff, Woodside, CA (US)

Correspondence Address: OLIFF & BERRIDGE, PLC, P.O. BOX 19928, ALEXANDRIA, VA, 22320, US

(73) Assignee: PALO ALTO RESEARCH CENTER INCORPORATED, Palo Alto, CA (US)

(21) Appl. No.: 11/210,841

(22) Filed: Aug. 25, 2005

(51) Int. Cl. B25J 3/00

(52) U.S. Cl. 414/1

(57) ABSTRACT

A portable, wearable active appendage, including an arm having a base end and a working end, a docking plate that mechanically and electrically connects the base end to a mounting base, an end-effector mechanically connected to the working end, and a controller that controls movement. In various embodiments the arm is reversible, has multiple degrees of freedom of motion, the mounting base is attached to clothing worn by a human, and the controller can learn a movement and controls the movement to replicate a human arm or control a motion that is relative to a human operator. In various embodiments the end-effector is also removably, electrically connected to the working end of the arm such that it can be replaced with a different end-effector. Some embodiments include a node that branches the arm into a Y shape. Some embodiments include verbal and manual user interfaces, a remote operator and a feedback device. Some embodiments include a plurality of appendages that can merge or split acting in concert.

### BACKGROUND

This application relates generally to active appendages, particularly active appendages that are portable and active appendages that may be worn by a human being.

It is not uncommon that a human being working alone on a manual task is unable to simultaneously hold all the tools and objects necessary to complete the task. It is also not uncommon that a human being working alone on a manual task is unable to simultaneously manipulate all the tools and objects necessary to complete the task. Still further, it is not uncommon for a person working alone on a manual task to be able to simultaneously hold and manipulate all required tools and objects, but only with difficulty.

At times the availability of another human being to assist in holding and manipulating tools or objects can be a solution to the impossibility or difficulty of a single person completing a task. However, the assistance of another human being is not always available. Further, in many applications, it may be preferable not to employ a second person to complete a task even though a second person would be available to assist in completing the task.

Others have attempted to address the problems described above by developing independent robots. For example, independently mobile robots are known for assisting elderly or disabled people. However, such robots are typically employed to perform large or complicated tasks. For example, a robot could be used for helping an invalid get into a chair, helping an invalid get out of a chair, or helping a human being carry a large heavy piece of furniture by carrying an opposite end of the piece of furniture.

The field of prosthetics is also known. In the field of prosthetics, a mechanical appendage is designed to replace an actual human appendage such as the human arm by replicating the abilities of a standard human arm to move, operate and perform tasks. Thus, a prosthetic appendage typically has a single fixed attachment point and a limited range of motion.

Devices such as vices have long been used to provide assistance in performing a task. However, the utility of vices is limited in several significant ways. For example, a vice needs to be fixed in a single location. Further, a vice only offers passive assistance. A vice is not able to move or actively assist in performing a task. Rather, a vice is only able to passively hold an object.

### SUMMARY

A portable active appendage that can be worn by a human being has utility in many ways. For example, during a space walk in a mission to space, the cost associated with each astronaut engaging in an extravehicular activity is enormous. Thus, the availability of a portable active appendage that can be worn by a human being can greatly reduce the cost associated with completing an extravehicular task in outer space. Further, by eliminating the need for an additional astronaut in the extravehicular activity, the risk of injury or loss of human life is reduced. Also, the elimination of the need for an additional astronaut to perform an extravehicular task in space may entirely eliminate the need for an extra astronaut on the trip to space. Naturally, in addition to an increase in safety, this would result in an enormous cost savings.

Another situation exemplifying the utility of a portable wearable active appendage is a situation where a human being needs to perform a task in a confined space. If the task is difficult or impossible to perform with two hands, and the confined space in which the task needs to be performed is too small for another human being to assist with the task, then the utility of an active appendage that may be worn on the body of the single human being performing the task is evident.

In various exemplary embodiments a portable active appendage is provided that may be worn by a human being.

In various exemplary embodiments, a portable active appendage is provided that may be worn by a human being and removably attached to one or more points on the wearer's body.

In various exemplary embodiments, a portable active appendage is provided that may be worn by a human being and operated to work simultaneously in conjunction with one or both of the wearer's arms.

In various exemplary embodiments, a portable active appendage is provided that is wearable by a human being and is small.

In various exemplary embodiments, a portable active appendage is provided that is wearable by a human being and is light weight.

In various exemplary embodiments, a portable active appendage is provided that is wearable by a human being and includes a high degree of freedom.

In various exemplary embodiments, a portable active appendage is provided that is wearable by a human being and includes a plurality of interchangeable end-effecters.

In various exemplary embodiments, a portable active appendage is provided that is wearable by a human being and is connected to a mounting point on clothing worn by the person.

In various exemplary embodiments, a portable active appendage is provided that is wearable by a human being and both mechanically and electrically connected to a mounting point on clothing worn by the human being.

In various exemplary embodiments, a portable active appendage is provided that is wearable by a human being and is connected to clothing worn by the human being via a standard mounting point.

In various exemplary embodiments, a portable active appendage is provided that is wearable by a human being and is attached to special clothing worn by the human being.

In various exemplary embodiments, a portable active appendage is provided that is wearable by a human being and is attached on the human being's chest.

In various exemplary embodiments, a portable active appendage is provided that may be worn by a human being such that the appendage moves with the wearer when the wearer turns, walks or otherwise engages in bodily motion.

In various exemplary embodiments, a portable active appendage is provided that is wearable by a human being who controls the appendage and controls an end-effecter of the appendage by means of a verbal user interface.

In various exemplary embodiments, a portable active appendage is provided that is wearable by a human being who controls the appendage and controls its end-effecter by means of a manipulative user interface.

In various exemplary embodiments, a portable active appendage is provided that is wearable by a human being and controlled by a second person remote from the wearer.

In various exemplary embodiments, a portable active appendage is provided that is wearable by a human being and capable of operating so as to reconfigure its own structural arrangement.

In various exemplary embodiments, a portable active appendage is provided that is wearable by a human being and capable of changing an end-effecter mounted at the end of the appendage.

In various exemplary embodiments, a portable active appendage is provided that is wearable by a human being and capable of unattaching itself from a base attachment point and reattaching itself to a second, different base attachment point.

In various exemplary embodiments, a portable active appendage is provided that is wearable by a human being and capable of changing its length.

A portable active appendage is provided that is wearable by a human being and capable of changing its own shape.

In various exemplary embodiments, a portable active appendage is provided that is a powered appendage wearable by a human being and capable of providing assistance to the wearer for performing a task.

In various exemplary embodiments, a portable active appendage is provided that is wearable by a human being and capable of engaging in a motion symmetrically mimicking a bodily motion of its wearer.

In various exemplary embodiments, a portable active appendage is provided that is wearable by a human being and provides feedback to an operator of the portable active appendage.

In various exemplary embodiments, a portable active appendage is provided that is wearable by a human being and provides feedback to an operator of the portable active appendage in the form of force feedback.

In various exemplary embodiments, a portable active appendage is provided that is wearable by a person and capable of performing a task on an object in relative motion.

In various exemplary embodiments, a portable active appendage is provided that is wearable by a human being and capable of combining manual control with a programmed action for performing a repetitive task.

In various exemplary embodiments, a portable active appendage is provided that is wearable by a human being and capable of performing a motion or an action that a human being is not capable of performing. For example, in various exemplary embodiments, a portable active appendage is provided that is wearable by a person and capable of rotating through 360 degrees of rotation or more.

In various exemplary embodiments, a portable active appendage is provided that is wearable by a human being and includes an end-effecter such as a claw, hook, drill, clamp, probe, vice, light, flashlight, camera, soldering iron and so forth. In various exemplary embodiments, the end-effecter is interchangeably removable from the appendage.

In various exemplary embodiments, a portable active appendage is provided that is wearable by an astronaut on a space suit.

In various exemplary embodiments, a portable active appendage is provided that is wearable by a human being and includes a user interface that is capable of posable programming.

In various exemplary embodiments, a portable active appendage is provided that is wearable by a human being and controllable by controls on clothing worn by the user, such as, for example, buttons, switches or a joystick.

In various exemplary embodiments, a portable active appendage is provided that is wearable by a human being and includes a chain of modules that each have one degree of freedom of motion.

In various exemplary embodiments, a portable active appendage is provided that is wearable by a human being and includes an articulating cube as a component.

In various exemplary embodiments, a portable active appendage is provided that is wearable by a human being and includes a connecting face having electrical and mechanical connections.

In various exemplary embodiments, a portable active appendage is provided that is wearable by a human being and includes a cube or other geometric figure having a plurality of connecting faces for connecting other portions of the appendage.

In various exemplary embodiments of the connecting faces described above, the plurality of connecting faces are each identical to one another. In various other exemplary embodiments of the connecting faces described above, one or more of the plurality of faces are different than one or more of the other faces.

These and other problems overcome by, and other features and advantages of this invention, are described in, or are apparent from, the following detailed description of various exemplary embodiments according to this invention.

### BRIEF DESCRIPTION OF THE DRAWINGS

Various exemplary embodiments of this invention will be described in detail, with reference to the following figures, wherein:

FIG. 1 is a perspective view of a first embodiment of a portable wearable active appendage;

FIG. 2 is an exemplary embodiment of an articulating cube including an exemplary embodiment of a docking plate for use in connection with a portable wearable active appendage;

FIG. 3 is an exploded view of the articulating cube of FIG. 2;

FIG. 4 is a perspective view of an exemplary embodiment of an attachment cube for use in connection with a portable wearable active appendage;

FIG. 5 is a perspective view of a second exemplary embodiment of a portable wearable active appendage; and

FIG. 6 is a perspective view of a third exemplary embodiment having two exemplary portable wearable active appendages.

### DETAILED DESCRIPTION OF EMBODIMENTS

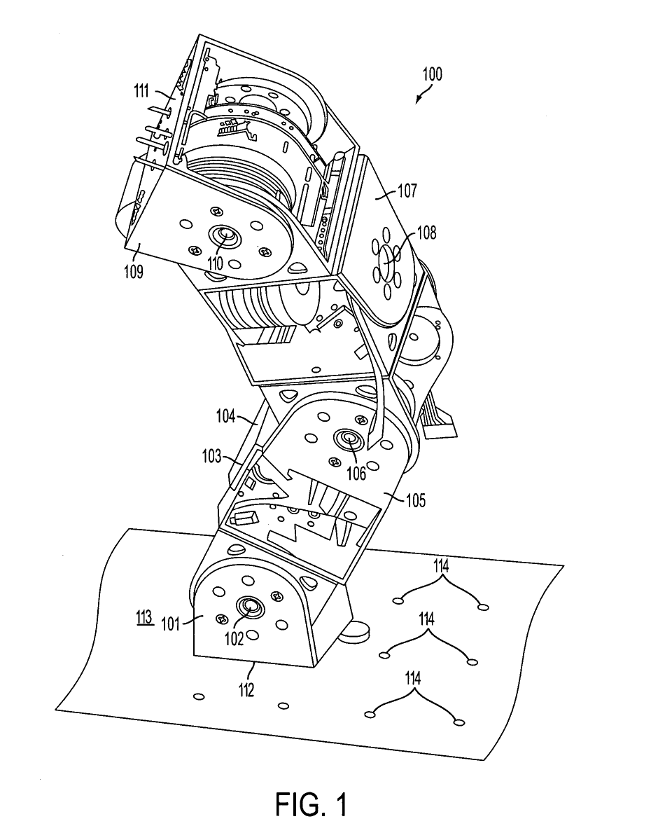

FIG. 1 is a perspective view of a first embodiment of a portable wearable active appendage 100. The first exemplary embodiment of a portable wearable active appendage 100 includes a first axis of rotation 102, a second axis of rotation 104, a third axis of rotation 106, a fourth axis of rotation 108, and a fifth axis of rotation 110. The interconnectedness of the first axis of rotation 102, the second axis of rotation 104, the third axis of rotation 106, the fourth axis of rotation 108, and the fifth axis of rotation 110 form a chain. Each axis of rotation within the chain relates to a single degree of freedom of motion. By combining five successive degrees of freedom of motion, the first exemplary embodiment of a portable wearable active appendage 100 achieves a very high degree of freedom of motion.

The first axis of rotation 102 is surrounded by a first module 101. The second axis of rotation 104 is surrounded by a second module 103. The third axis of rotation 106 is surrounded by a third module 105. The fourth axis of rotation 108 is surrounded by a fourth module 107. The fifth axis of rotation 110 is surrounded by a fifth module 109.

The first module 101 is electrically and mechanically connected to the second module 103. The second module 103 is electrically and mechanically connected to the third module 105. The third module 105 is electrically and mechanically connected to the fourth module 107. The fourth module 107 is electrically and mechanically connected to the fifth module 109. Thus, the sequence of electrical and mechanical connections is maintained such that mechanical motion may be transmitted throughout each module 101, 103, 105, 107, 109 in the exemplary embodiment of portable wearable active appendage 100, and an electrical signal may be transmitted through the entire exemplary portable wearable active appendage 100 from the first module 101 to the fifth module 109.

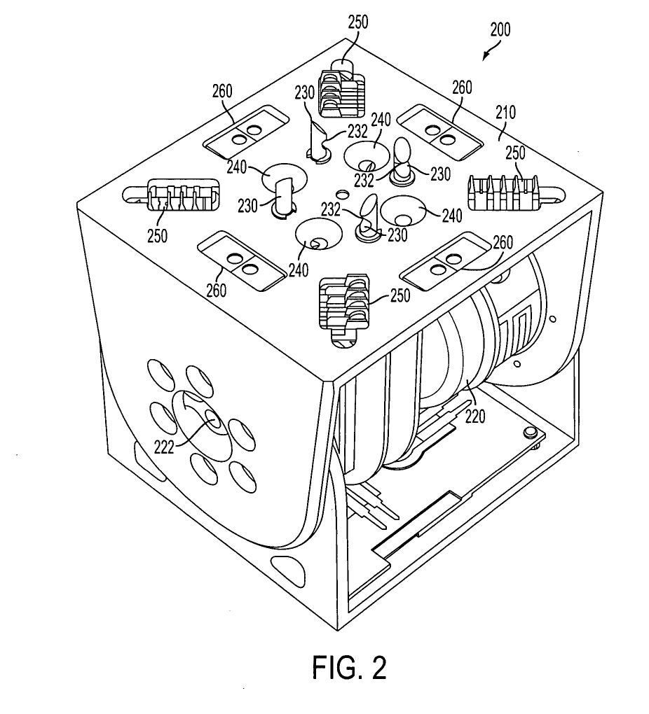

Further, the exemplary embodiment of the portable wearable active appendage 100 includes a first connecting face 111 and a second connecting face 112. The second connecting face is connected to a base mount 113 such that the connecting face 112 is not visible in FIG. 1. The first connecting face 111 is visibly exposed in FIG. 1. In various exemplary embodiments, the first connecting face 111 and the second connecting face 112 are identical. In various other exemplary embodiments, the first connecting face 111 and the second connecting face 112 are not identical. More detail regarding the connecting faces 111, 112 will be described below in connection with FIGS. 2-6.

In various exemplary embodiments, the base mount 113 is provided with additional mounting points 114. Thus, in the embodiments where the first connecting face 111 and the second connecting face 112 are both compatible with the mounting points 114, either of the first connecting face 111 and the second connecting face 112 may be connected to the base mount 113. Further, in these exemplary embodiments, the first exemplary embodiment of the portable wearable active appendage 100 may be articulated to connect the first connecting face 111 to connecting points 114 while the second connecting face 112 remains connected to the base mount 113. Subsequently, in various exemplary embodiments, the second connecting face 112 may be disconnected from the base mount 113 leaving connecting face 111 as the only portion of the exemplary portable wearable active appendage 100 that is connected to the base mount 113. In this manner, exemplary portable wearable active appendage 100 is capable of reversing its orientation. Also, exemplary portable wearable active appendage 100 is capable of remounting itself to a different mounting point. The structure of the various components described above in connection with the first exemplary embodiment of a portable wearable active appendage 100 will now be described in greater detail in connection with FIG. 2.

FIG. 2 is an exemplary embodiment of an articulating cube 200 including an exemplary embodiment of a docking plate 210. The exemplary articulating cube 200 is a component for use in a portable wearable active appendage.

As depicted in FIG. 2, the exemplary articulating cube 200 has the dimensions of a cube. In other exemplary embodiments, the articulating cube 200 has dimensions that are approximately equal to a cube. In other exemplary embodiments, an articulating connector is used that is not shaped like a cube.

The exemplary articulating cube 200 has two faces that are docking plates 210. In the depicted embodiment, the two docking plates 210 are on opposite faces of the exemplary articulating cube 200. Thus, only one docking plate 210 is visible in the perspective view of FIG. 2.

The docking plate 210 acts as a means of interface between other components of a portable active appendage worn by a person. The articulating cube 200 also includes a motor 220. The motor is used to rotate the opposing two docking plates 210 with respect to each other along axis 222.

The docking plate 210 of exemplary articulating cube 200 includes four pins 230. The four pins 230 are used for mechanical connection of the exemplary articulating cube 200 with another exemplary articulating cube 200 or other attachment point of the portable active appendage such as a base plate. Thus, when mating with another part of the portable active appendage, four holes 240 mate with four pins 230 on the other attachment part.

The pins 230 include notches 232 or other means of securing the mechanical connection between the articulating cube 200 and the other part of the portable active appendage to which the exemplary articulating cube 200 attaches by use of the pins 230.

The exemplary articulating cube 200 also includes four infrared emitter/detector pairs 260. The infrared emitter/detector pairs 260 are used for orientation of the docking plate 210 and the other component of the portable active appendage to which the docking plate 210 is mating. The orientation achieved by the infrared emitter/detector pairs 260 enables control for guiding the docking plate 210 together with the other component of the portable active appendage to which the docking plate is mating. This technology is described in greater detail in U.S. Patent Publication No. 2003/0107737.

The exemplary articulating cube 200 also includes four connector housings 250. The connector housings 250 include two different sets of pins. The two different sets of pins in the exemplary connector housings 250 are used to provide electrical power to the device and electrical communications to the device, respectively. In this manner, the portable active appendage is able to maintain electrical power and electrical communications throughout a network of connected modules including exemplary articulating cubes 200.

Thus, in the manner described above, the modules 101, 103, 105, 107, 109 in the exemplary embodiment of portable wearable active appendage 100 correspond to five exemplary articulating cubes 200 connected in series. In a similar manner, the first axis of rotation 102, the second axis of rotation 104, the third axis of rotation 106, the fourth axis of rotation 108 and the fifth axis of rotation 110 correspond to five instances of axis 222.

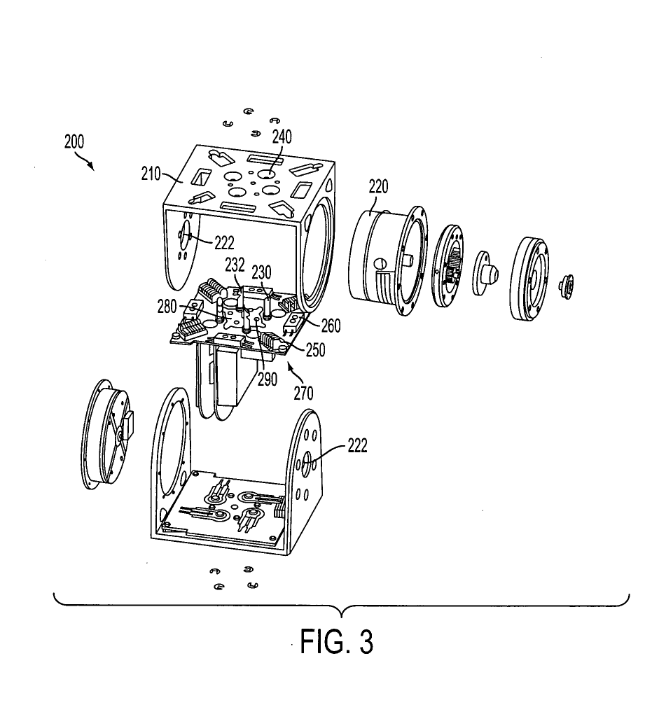

FIG. 3 is an exploded view of the exemplary articulating cube 200. The exploded view of FIG. 3 makes it possible to see an exemplary embodiment of a latch mechanism for the exemplary articulating cube 200. All of the separate pieces of the exemplary articulating cube 200 are mechanically attached to the PCB 270. Central latch 280 pivots on a central pin in this exemplary embodiment of a latch mechanism. In this exemplary embodiment of the latch mechanism, a shaped memory alloy wire runs from each corner of the PCB 270 around a second set of pins 290.

In various exemplary embodiments, a voltage is applied to the shaped memory alloy wire causing the shaped memory alloy wire to contract in length. In various exemplary embodiments, the contraction of the shaped memory alloy wire caused by the application of a voltage in turn rotates the latch 280. In various exemplary embodiments, the rotation of the latch 280 moves the latch 280 away from the holes 240. In various exemplary embodiments, the movement of the latch 280 away from the holes 240 permits the notches 232 on the pins 230 to disengage and pass through the holes 240. In this manner, the mating and disengaging of various parts of a portable active appendage, including the docking plate 210 of exemplary articulating cube 200, is controlled by an electrical signal.

In various exemplary embodiments, after the pins 230 engage with the holes 240 of the mating face (docking plate 210), the current is turned off to the shaped memory alloy wires. In various exemplary embodiments, the removal of the electrical current from the shaped memory alloy wires causes the wires to cool. In various exemplary embodiments, the cooling of the shaped memory alloy wires causes the wires to shrink. In various exemplary embodiments, the shrinkage of the shaped memory alloy wires reverses the mechanical latching process described above enabling the pins 230 to disengage from the holes 240. Thus, in various exemplary embodiments, the pins 230 engage in the holes 240 to secure the exemplary articulating cube through the docking plate 210.

In various exemplary embodiments, the latch mechanism 280 includes four springs mounted on the face of the PCB 270. The springs apply a force to the latch mechanism 280 that urges the latch mechanism 280 back into the closed position where the latch mechanism 280 engages the pins 230 from the mating face (docking plate 210) of the other component of the portable active appendage in this exemplary embodiment.

The view of the exemplary articulating cube 200 in FIG. 3 is exploded along more than one axis. The horizontal axes upon which the view of FIG. 3 is exploded corresponds to the axis of rotation 222 upon which the opposing docking plates 210 rotate with respect to each other.

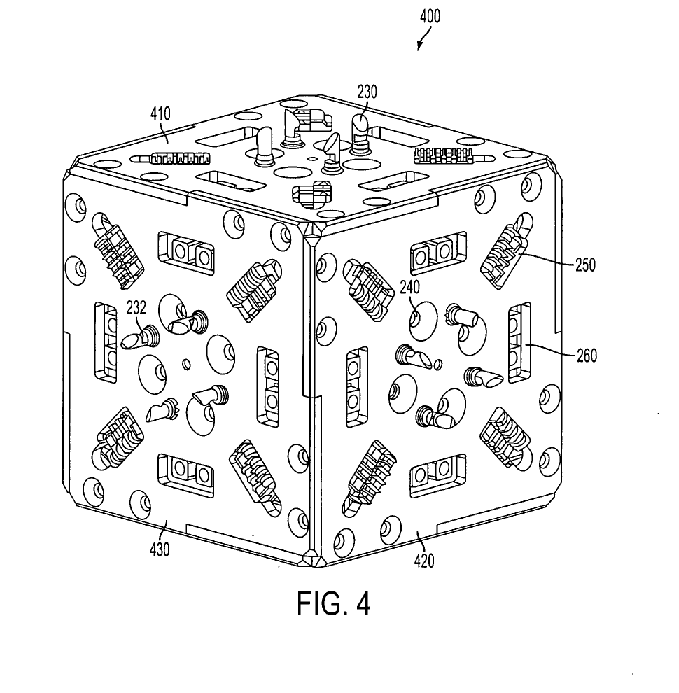

FIG. 4 is a perspective view of an exemplary embodiment of an attachment cube 400. The exemplary attachment cube 400 is used as a component in various exemplary embodiments of a portable wearable active appendage. As shown in FIG. 4, the exemplary attachment cube 400 has three visible faces, attachment face 410, attachment face 420 and attachment face 430. Three other attachment faces of the cube are hidden behind attachment face 410, attachment face 420 and attachment face 430 in the perspective view of exemplary attachment cube 400 shown in FIG. 4.

In the exemplary embodiment shown, all of the attachment faces 410, 420, 430 of exemplary attachment cube 400 are identical. In various other exemplary embodiments, an attachment cube 400 is provided having faces that are not identical.

In this exemplary embodiment, the attachment faces 410, 420, 430 are identical to docking plate 210. Thus, each attachment face 410, 420, 430 includes four pins 230 having notches 232, four holes 240 for mating with the four pins 230 on another docking plate 210 acting as a mating face of another attachment part of the portable active appendage, four connector housings 250 including two sets of pins that provide electrical power and electrical communications to the device, and four infrared emitter/detector pairs 260 used for orienting the attachment faces 410, 420, 430 when mating with other components of the portable active appendage.

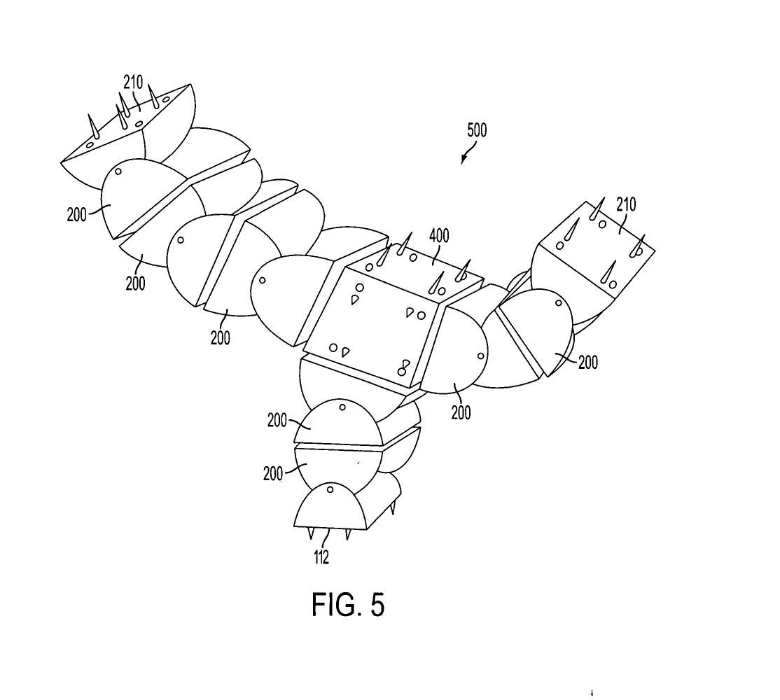

FIG. 5 is a perspective view of second exemplary embodiment of a portable wearable active appendage 500. In the exemplary embodiment of a portable wearable active appendage 500, seven exemplary articulating cubes 200 are implemented in connection with one exemplary attachment cube 400 to create an exemplary portable wearable active appendage that has one base connection point 112 and two exposed docking plates 210 at working ends of a branched arm. According to one nomenclature, the shape of the exemplary appendage 500 is referred to as a Y shape. In various exemplary embodiments, interchangeable end-effectors are attached to the docking plates 210 at the working ends of the exemplary appendage 500. These end-effectors will be described in greater detail below.

In the manner described above, in various exemplary embodiments, the exemplary attachment cube 400 is used as a node for connecting various components of the portable active appendage. Because each of the attachment faces 410, 420, 430 are identical to the docking plate 210 described above in connection with FIGS. 2 and 3, exemplary attachment cube 400 functions as another component that can be used in the portable active appendage to achieve interconnectedness of various parts and components of the appendage.

In this manner, the exemplary attachment cube 400 is used in various exemplary embodiments for the portable active appendage to branch into multiple arms having multiple end-effectors attached thereto. Thus, the exemplary attachment cube 400 is used in various exemplary embodiments to enable a portable active appendage having a multitude of shapes.

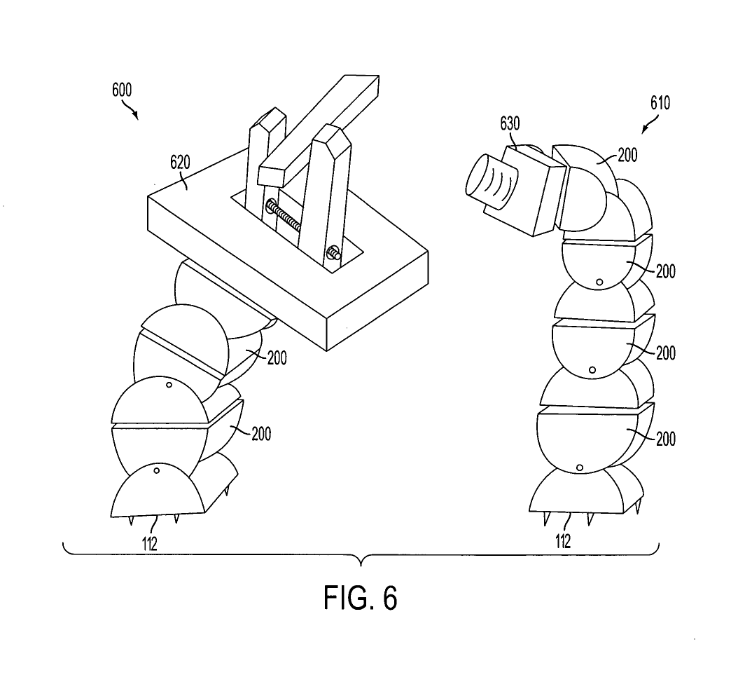

FIG. 6 is a perspective view of third exemplary embodiment including exemplary portable wearable active appendage 600 and exemplary portable wearable active appendage 610. In this third exemplary embodiment, portable wearable active appendage 600 and portable wearable active appendage 610 work together in a single application.

The exemplary appendage 600 and exemplary appendage 610 each consist of a chain of exemplary articulating cubes 200 connected in series. Each of exemplary appendage 600 and exemplary appendage 610 are attached at a base point 112.

In the exemplary embodiment depicted in FIG. 6, exemplary appendage 600 has an end-effector attached at a working end of the exemplary appendage 600 that is a claw 620. The exemplary appendage 610 has an end-effector attached at a working end of the appendage 610 that is a camera 630. Other examples of end-effectors that are employed in various exemplary embodiments of the portable wearable active appendage 600, 610 include a flashlight, a light, a drill, a soldering iron, a hook, and so forth.

In the exemplary embodiment depicted in FIG. 6, exemplary appendage 600 and exemplary appendage 610 work in harmony so that the camera 630 provides a visual image of the claw 620. In this manner, a remote operator may control the movement of the claw 620 based on an image or images provided by the camera 630. Likewise, in an embodiment where exemplary appendage 600 and exemplary appendage 610 are both attached to the body of a human operator, images obtained from the camera 630 may be archived for later analysis of work performed by the claw 620 operated by the human wearer of the exemplary appendage 600 and exemplary appendage 610.

In various exemplary embodiments, exemplary appendage 600 and exemplary appendage 610 are attached to over-clothing worn by a human operator on top of the human operator's regular clothing. For example, in various exemplary embodiments, exemplary appendage 600 and exemplary appendage 610 are attached to a space suit. In various other exemplary embodiments, exemplary appendage 600 and exemplary appendage 610 are attached to a vest.

In various exemplary embodiments, a verbal user interface is provided to actuate operations performed by the end-effector in response to verbal commands given by the human user. For example, the verbal commands ON and OFF are understood by a verbal user interface in various exemplary embodiments to control the operation of the exemplary camera 630. Likewise, the verbal commands GRASP and LET GO are understood by the verbal user interface in various exemplary embodiments to control the operation of the exemplary claw 620. Similarly, the verbal commands UP, DOWN, LEFT, RIGHT, ROTATE, and so forth, are understood in various exemplary embodiments to control the movement of the various articulating cubes 200 comprising each exemplary appendage 600, 610. In various exemplary embodiments, these commands are understood by the verbal user interface to control the movement of the appendage 600, 610 to relocate the claw 620, camera 630, or other end-effector attached to the working end of the appendage 600, 610.

In various exemplary embodiments, a manipulative user interface is provided to control the movement of the exemplary appendage 600, 610 and to control the movement of the end-effector attached to the working end of the appendage 600, 610. For example, in various exemplary embodiments, a joystick is provided. In various exemplary embodiments, the human user manipulates the joystick physically and the exemplary appendage 600, 610 responds to the movement of the joystick.

In various exemplary embodiments, a joystick is provided on the back of a glove worn on a wrist of the human user. In various exemplary embodiments, the human user is able to manipulate the joystick on the back of the glove with the other hand. In various exemplary embodiments, the joystick or other manual user interface is provided on another part of the wearer's clothing that can be accessed by the wearer's hand for manipulation and control.

In various other exemplary embodiments of a manipulative user interface, the human user wears a glove including sensors and the exemplary appendage 600, 610 mimics movement of the human wearer's hand based on movement of the hand sensed by the sensors in the glove worn by the user. Similarly, in various exemplary embodiments, sensors are provided to detect movement of the human arm and imitate the movement of that arm with exemplary appendage 600, 610. In some of these exemplary embodiments the human user is remote from the appendage 600, 610. In others of these exemplary embodiments the human user is local to the appendage 600, 610, even wearing the appendage 600, 610.

In various exemplary embodiments, a verbal user interface is provided at a distance from the exemplary appendage 600, 610. In various exemplary embodiments, a manipulative user interface is provided at a distance from the exemplary appendage 600, 610. In various exemplary embodiments, both a verbal user interface and a manipulative user interface are provided at a distance from the exemplary appendage 600 and the exemplary appendage 610.

In various exemplary embodiments, more than one manipulative user interface is provided. Thus, in one exemplary embodiment, an astronaut in a control ship views a display of images sent from a remote location by the camera 630 and controls actions of the claw 620 and movement of the appendages 600, 610 through a verbal user interface, a joystick and a sophisticated set of several other manipulative user interfaces such as buttons and so forth. In this exemplary embodiment, the astronaut wearing the portable active appendage 600 and the portable active appendage 610 on a spacesuit may have little control over the operation of the portable active appendage 600 and the portable active appendage 610, but might provide verbal feedback to the control ship astronaut that is controlling the operations of the portable active appendage 600, the portable active appendage 610 and the end-effectors attached to those appendages 600, 610.

In various exemplary embodiments, the portable active appendage 600, 610 is capable of reconfiguring itself. Thus, in various exemplary embodiments, the portable active appendage 600, 610 is capable of dropping one end-effector and connecting another end-effector. For example, in various exemplary embodiments, a series of different end-effectors are stored in a rack, and the portable active appendage 600, 610 drops an end-effector that had been connected to a working end of the portable active appendage 600, 610 in a location in the rack specified for that particular end-effector and then connects the working end of the portable active appendage 600, 610 to another end-effector in another storage location in the rack.

In various exemplary embodiments, the user of the portable wearable active appendage 600, 610 receives feedback from the appendage 600, 610 in the form of force feedback. For example, in various exemplary embodiments, the user wears a powered glove that provides force feedback from the appendage 600, 610. Thus, for example, force feedback is provided from the appendage 600, 610 regarding the weight of an object that is being lifted by the appendage 600, 610. Thus, in various exemplary embodiments, the power glove squeezes the hand of its wearer harder the heavier the object being lifted by the appendage 600, 610. In some of these exemplary embodiments the human user is remote from the appendage 600, 610. In others of these exemplary embodiments the human user is local to the appendage 600, 610, even wearing the appendage 600, 610.

In various exemplary embodiments, a docking plate 210 is provided on the surface of a piece of equipment or an object in a vicinity where the use of the portable active appendage 600, 610 is determined to be likely. Thus, in various other exemplary embodiments, one or more docking plates 210 are provided in a vest to be worn by a human user. In various other exemplary embodiments, one or more docking plates 210 are provided on the surface of a satellite in outer space.

In various exemplary embodiments, the appendage 600, 610 is configured to work on an object in relative motion. Thus, in various exemplary embodiments, the human wearer of the portable active appendage 600, 610 sits in a chair that rolls or otherwise moves while the portable active appendage 600, 610 is capable of working on an object on top of a desk that remains stationary while the wearer is moving in the chair. In various exemplary embodiments, a CCD camera is employed to observe relative motion and to provide data regarding the relative motion and enable a controller to compensate for the relative motion in the portable active appendage 600, 610.

In various exemplary embodiments, manual control of the portable active appendage 600, 610 is combined with an action for the portable active appendage 600, 610 that is programmed. For example, in various exemplary embodiments, repetitive tasks are programmed in a controller that controls the motion of the portable active appendage 600, 610. For example, in some embodiments, the appendage 600 is programmed to hold a hammer and hit a nail with the hammer. In this exemplary embodiment, the second appendage 610 is used to manually pick up and position each nail that will be struck by the hammer.

Similarly, in various exemplary embodiments, a controller is provided that is capable of recording a motion or task performed by the portable active appendage 600, 610 and repeating that motion or task. According to one nomenclature, this ability to learn or train through example is referred to as poseable programming. Thus, in various exemplary embodiments, the portable wearable active appendage is capable of poseable programming, such as that described in U.S. Pat. No. 6,454,624.

In various exemplary embodiments, the portable active appendage 600, 610 is capable of performing a motion or action that a human appendage could not perform. For example, in various exemplary embodiments, a rotating disk is provided that enables the portable active appendage 600, 610 to rotate continuously. In various exemplary embodiments, this functionality is employed to turn a screwdriver until a screw is completely secured without having to repeatedly remove and regrip the screwdriver as would be necessary to perform the task with a human arm. Likewise, this functionality is used in various exemplary embodiments to turn a knot.

In various exemplary embodiments, a portable wearable active appendage 600, 610 is employed in an application less sophisticated than an astronaut in outer space. For example, in various exemplary embodiments, a tradesman working on a house employs an embodiment of a portable wearable active appendage 600, 610 to perform a task associated with that work.

In various exemplary embodiments, one or more of the features described above in connection with the third exemplary embodiment of portable wearable active appendage 600 is implemented in connection with the first exemplary embodiment of a portable wearable active appendage 100, the second exemplary embodiment of a portable wearable active appendage 500, or some other embodiment of a portable wearable active appendage.

In the manner described above, various exemplary embodiments include a portable wearable active appendage with attachment points on a human user. In various exemplary embodiments, motion is relative to the user rather than the environment. In various exemplary embodiments, a portable wearable active appendage is provided that is portable with a human wearer and is capable of operation without the need for using the wearer's human hands. In various exemplary embodiments, a portable wearable active appendage is provided that is actively controlled with many degrees of freedom. In various exemplary embodiments, a portable wearable active appendage is provided that is adaptable through self-reconfiguration of shape and of end-effectors.

According to the subject matter described above, in various exemplary embodiments, a plurality of portable wearable active appendages are provided. In various exemplary embodiments, a plurality of portable wearable active appendages act in concert with one another. In various exemplary embodiments, a portable wearable active appendage is provided that branches into more than one branch from a single branch. In various exemplary embodiments, a portable wearable active appendage is provided that branches from one arm into two or more arms. Thus, in various exemplary embodiments, a portable wearable active appendage is provided that has a plurality of branches. Likewise, in various exemplary embodiments, a portable wearable active appendage is provided that has a complex shape. In various exemplary embodiments, a plurality of portable wearable active appendages are provided wherein the appendages have the ability to merge or split to form larger or smaller more complex or less complex shapes.

According to the subject matter described above, in various exemplary embodiments, a plurality of portable wearable active appendages are provided. In various exemplary embodiments, one or more portable wearable active appendages are provided that are mounted on clothing worn by a human user. In various exemplary embodiments, a plurality of portable wearable active appendages are provided wherein one or more of the appendages are mounted on a human wearer and one or more of the appendages are mounted in a location that is not on the body of the human wearer. For example, in various exemplary embodiments, one or more portable wearable active appendages are provided in an area where human use is anticipated. In various exemplary embodiments, a plurality of mounting points are provided in a workspace where use of a portable wearable active appendage is anticipated. Thus, in various exemplary embodiments, the relocation of one or more portable wearable active appendages is easily facilitated.

In various exemplary embodiments, a portable wearable active appendage is provided that includes one or more passive joints. In various exemplary embodiments, a portable wearable active appendage is provided with a mounting base that facilitates rapid attachment and detachment from equipment and surfaces.

In various exemplary embodiments, a controller is provided to control use of the portable wearable active appendage. In various exemplary embodiments, software is provided and implemented in a controller to control use of a portable wearable active appendage.

It will be appreciated that various of the above-disclosed and other features and functions, or alternatives thereof, may be desirably combined into many other different systems or applications. Also, various presently unforeseen or unanticipated alternatives, modifications or improvements therein may be subsequently made by those skilled in the art which are also intended to be encompassed by the following claims.

What is claimed is:

1. A portable, wearable active appendage, comprising:
an arm having a base end and a working end;
a docking plate that mechanically and electrically connects the base end of the arm to a mounting base;
an end-effector mechanically connected to the working end of the arm; and
a controller that controls movement of the arm and the end-effector.

2. The portable, wearable active appendage according to claim 1, wherein the arm has multiple degrees of freedom of motion.

3. The portable, wearable active appendage according to claim 1, wherein the docking plate includes a sensor that facilitates a mating of the docking plate and the mounting base.

4. The portable, wearable active appendage according to claim 1, wherein the mounting base is provided on a human wearer.

5. The portable, wearable active appendage according to claim 4, wherein the mounting base is attached to clothing worn by the human wearer.

6. The portable, wearable active appendage according to claim 1, wherein the end-effector is selected from the group consisting of a clamp, a probe, a camera, a light, a claw, a flashlight, a drill, a hook, and a soldering iron.

7. The portable, wearable active appendage according to claim 1, wherein the end-effector is electrically connected to the working end of the arm.

8. The portable, wearable active appendage according to claim 1, wherein the end-effecter is removably connected to the working end of the arm, and the end-effector can be replaced with a different end-effector.

9. The portable, wearable active appendage according to claim 1, further comprising a node having a plurality of docking plates that mechanically and electrically connect a first portion of the arm to a second portion of the arm and a third portion of the arm, the second portion of the arm and the third portion of the arm each having a working end.

10. The portable, wearable active appendage according to claim 1, wherein the controller controls the movement of the arm and the end-effector to replicate a movement of a human operator's arm.

11. The portable, wearable active appendage according to claim 1, wherein the controller controls the movement of the arm and the end-effector to operate the arm and the end-effector in a motion that is relative to a human operator.

12. The portable, wearable active appendage according to claim 1, wherein the base end and the working end of the arm are interchangeable.

13. The portable, wearable active appendage according to claim 12, wherein the working end and the base end of the arm can reverse by the working end attaching to a second mounting base and the base end disattaching from the mounting base.

14. The portable, wearable active appendage according to claim 1, further comprising a verbal user interface that provides control information to the controller.

15. The portable, wearable active appendage according to claim 1, further comprising a manual user interface that provides control information to the controller.

16. The portable, wearable active appendage according to claim 1, wherein a remote human user provides control information to the controller.

17. The portable, wearable active appendage according to claim 1, further comprising a feedback device that provides feedback to a human operator regarding the movement of the arm and the end-effector.

18. The portable, wearable active appendage according to claim 1, wherein the controller is capable of learning a movement performed by the arm and the end-effector and capable of memorizing that movement such that the controller can repeat the movement.

19. A plurality of portable, wearable active appendages, each of the portable, wearable active appendages comprising:
an arm having a base end and a working end;
a docking plate that mechanically and electrically connects the base end of the arm to a mounting base;
an end-effector mechanically connected to the working end of the arm; and
a controller that controls movement of the arm and the end-effector,
wherein each of the plurality of portable, wearable active appendages operates in connection with one or more of other ones of the plurality of portable, wearable active appendages.

20. The plurality of portable, wearable active appendages according to claim 19, wherein two or more of the plurality of portable, wearable active appendages can merge into a single appendage, and one of the plurality of portable wearable active appendages can split into two or more portable, wearable active appendages.
